(19) United States
(12) Patent Application Publication
(10) Pub. No.: US 2008/0294361 A1
(43) Pub. Date: Nov. 27, 2008

(54) Intelligent execution system for the monitoring and execution of vaccine manufacturing

(76) Inventor: Shane M. Popp, Santa Monica, CA (US)

Correspondence Address: Shane M. Popp;SMP Logic Systems LLC, Intellectual Property Department, 2804 6th Street, Santa Monica, CA, 90405, US

(21) Appl. No.: 12/152,409

(22) Filed: May 14, 2008

Related U.S. Application Data
(60) Provisional application No. 60/931,563, filed on May 24, 2007.

(51) Int. Cl. G06F 19/00

(52) U.S. Cl. 702/81

(57) ABSTRACT

Intelligent execution systems and methods thereof used to monitor and execute a vaccine manufacturing process are disclosed herein. Consequently, the methods and systems provide a means to perform validation and quality manufacturing on an integrated level whereby vaccine manufacturers can achieve data and product integrity and ultimately minimize cost.

### CROSS-REFERENCE TO RELATED APPLICATIONS

This application claims priority to U.S. Provisional Patent Application No. 60/931,563 filed 24 May 2007, the contents of which are fully incorporated by reference herein.

### STATEMENT OF RIGHTS TO INVENTIONS MADE UNDER FEDERALLY SPONSORED RESEARCH

Not applicable.

### FIELD OF THE INVENTION

The invention described herein relates to the field of vaccine manufacturing. Specifically, intelligent execution systems and methods used for the monitoring and execution of vaccine manufacture. The invention further relates to the enhancement of computer system technologies and information technology to produce higher quality more efficient vaccines.

### BACKGROUND OF THE INVENTION

Previously we have described novel methods, systems, software programs, and manufacturing execution systems for validation, quality and risk assessment, and monitoring of pharmaceutical manufacturing processes. See, US2005/0251278 published 10 Nov. 2005; US2006/0276923 published 7 Dec. 2006; US2006/0271227 Published 30 Nov. 2006; US2007/0021856 Published 25-Jan.-2007; and US2007/0032897 Published 08-Feb.-2007. Additionally, we endeavor to further the state of the art using software and computer programming in the field of vaccine manufacture.

Vaccines against various and evolving strains of influenza, among other things, are important not only from a community health standpoint, but also commercially, since each year numerous individuals are infected with different strains and types of influenza virus and other diseases. Infants, the elderly, those without adequate health care and immuno-compromised persons are at special risk of death from such infections. Compounding the problem of infections is that novel strains evolve readily, thereby necessitating the continuous production of new vaccines. Numerous vaccines capable of producing a protective immune response specific for such different viruses have been produced for over 50 years and include, e.g., whole virus vaccines, split virus vaccines, surface antigen vaccines and live attenuated virus vaccines. However, while appropriate formulations of any of these vaccine types are capable of producing a systemic immune response, live attenuated virus vaccines have the particular advantage of being also able to stimulate local mucosal immunity in the respiratory tract. A vaccine comprising a live attenuated virus that is capable of being quickly and economically produced and that is capable of easy storage/transport is thus quite desirable. Also desirable would be methods to increase production efficiency and production yield of such viruses, and thus of vaccines for such viruses, especially for virus strains that have proven difficult to produce and/or scale up for commercial production using traditional methods.

Additionally, the globalization of vaccine manufacturing requires a global approach to integration keeping in mind the overall objective of strong public health protection. To accomplish these needed goals there is a need to carry out the following actions. The artisan should use emerging science and data analysis to enhance validation and quality assurance programs during the manufacturing process. From the aforementioned, also apparent to one of ordinary skill in the art is the ability to provide an integrated approach to manufacturing whereby quality and manufacturing variables are monitored continuously during manufacture. By providing an integrated and user friendly approach to validation and quality assurance the overall benefit to the public at-large is vaccine end products available at lower costs. This is turn will allow more persons or animals to benefit from innovations that occur in the treatment of disease.

Given the current deficiencies associated with vaccine manufacture and the fact that the demand from a public health standpoint is increasing, it becomes clear that providing an integrated systems approach to vaccine manufacture is desirable. Specifically, producing vaccines from a “quality by design” approach (i.e. where quality is in designed in the production versus testing quality post-production) is advantageous. The present invention provides this solution.

### SUMMARY OF THE INVENTION

The invention provides for intelligent execution systems (“IES”) and methods thereof designed for use in manufacturing vaccines. Specifically, software programs that monitor quality control and the quality process used in the manufacture, processing, and storing of vaccines. In certain embodiments, the software programs are used in a continuous manner to ensure purity and consistency of an ingredient used in vaccine manufacture.

The invention further comprises a software program that is integrated into an IES used to monitor the entire vaccine manufacturing process.

The invention further comprises integrating the IES into a vaccine manufacturing system whereby control of the vaccine manufacturing process is attained.

In certain embodiments, the IES is integrated into an upstream processing system used in vaccine manufacturing.

In certain embodiments, the IES is integrated into a cell harvest and product separation system used in vaccine manufacturing.

In certain embodiments, the IES is integrated into a downstream processing and purification system used in vaccine manufacturing.

In certain embodiments, the IES is integrated into formulation systems used in vaccine manufacturing.

In certain embodiments, the IES is integrated into filling systems used in vaccine manufacturing.

In certain embodiments, the IES is integrated into a cell culture system used in vaccine manufacture.

In certain embodiments, the IES is integrated into a recombinant DNA-based system used in vaccine manufacture.

In certain embodiments, the IES comprises a software program with a computer memory having computer readable instructions.

Based on the foregoing non-limiting exemplary embodiments, the software program can be interfaced with the hardware systems to monitor quality assurance protocols put in place by the quality control unit.

The invention further comprises an IES which integrates application software and methods disclosed herein to provide a comprehensive validation and quality assurance protocol that is used by a plurality of end users whereby the data compiled from the system is analyzed and used to determine if quality assurance protocols and validation protocols are being achieved.

The invention further comprises implementing the IES and software program to multiple vaccine product lines whereby simultaneous vaccine production lines are monitored using the same system.

The invention further comprises implementation of the IES and software program described herein into the media filtration processes, the aeration processes, the inoculation processes, the fermentation processes, the exhaust processes, the depth filtration processes, the tangential flow filtration, the buffer filtration processes, the capture chromatography processes, the liquid filtration, the concentration diafiltration processes, the purification chromatography processes, the air filtration processes, the storage processes, the polishing chromatography processes, the virus removal filtration, the formulation processes, and the filling processes subset of the vaccine manufacturing process whereby the data compiled by the subset processes is tracked continuously overtime and said data is used to analyze the subset processes and whereby said data is integrated and used to analyze the quality control process of the vaccine manufacturing process at-large.

The invention further comprises an intelligent execution system, which controls the vaccine manufacturing process and increases productivity and improves quality of vaccines over time.

### BRIEF DESCRIPTION OF THE FIGURES

FIG. 1. Schematic of an IES integrated into the upstream processing system used in vaccine manufacture. As shown in the figure, the entire upstream processing system is integrated into the IES. Data is monitored at critical control points to ensure quality parameters are being achieved. The data is monitored and analyzed on a continuous basis.

FIG. 2. Schematic of an IES integrated into the cell harvest and product separation system used in vaccine manufacture. As shown in the figure, the entire cell harvest and product separation system is integrated into the IES. Data is monitored at critical control points to ensure quality parameters are being achieved. The data is monitored and analyzed on a continuous basis.

FIG. 3. Schematic of an IES integrated into the downstream processing and purification system used in vaccine manufacture. As shown in the figure, the entire downstream processing and purification system is integrated into the IES. Data is monitored at critical control points to ensure quality parameters are being achieved. The data is monitored and analyzed on a continuous basis.

FIG. 4. Schematic of an IES integrated into a plasmid (DNA) based system used in vaccine manufacture. As shown in the figure, the entire plasmid (DNA) system is integrated into the IES. Data is monitored at critical control points to ensure quality parameters are being achieved. The data is monitored and analyzed on a continuous basis.

### DETAILED DESCRIPTION OF THE INVENTION

### Outline of Sections

I.) Definitions

II.) Software Program and Computer Product

III.) Analysis

IV.) Intelligent Execution System (“IES”)

V.) KITS/Articles of Manufacture

### I.) Definitions

Unless otherwise defined, all terms of art, notations and other scientific terms or terminology used herein are intended to have the meanings commonly understood by those of skill in the art to which this invention pertains unless the context clearly indicates otherwise. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art, such as, for example, the widely utilized current Good Manufacturing Practice guidelines.

As used herein the term “vaccine” means an antigenic preparation used to establish immunity to a disease. Vaccines can be prophylactic (e.g. to prevent or ameliorate the effects of a future infection by any natural or “wild” pathogen), or therapeutic (e.g. cancer vaccines). As used herein. vaccine includes veterinary and human vaccines, including human biological vaccines.

“interface” means the communication boundary between two or more entities, such as a piece of software, a hardware device, or a user. It generally refers to an abstraction that an entity provides of itself to the outside. This separates the methods of external communication from internal operation, and allows it to be internally modified without affecting the way outside entities interact with it, as well as provide multiple abstractions of itself. It may also provide a means of translation between entities which do not speak the same language, such as between a human and a computer. The interface between a human and a computer is called a user interface. Interfaces between hardware components are physical interfaces. Interfaces between software exist between separate software components and provide a programmatic mechanism by which these components can communicate.

“abstraction” means the separation of the logical properties of data or function from its implementation in a computer program.

“adaptive maintenance” means software maintenance performed to make a computer program usable in a changed environment.

“algorithm” means any sequence of operations for performing a specific task.

“algorithm analysis” means a software verification and validation (“V&V”) task to ensure that the algorithms selected are correct, appropriate, and stable, and meet all accuracy, timing, and sizing requirements.

“analog” means pertaining to data [signals] in the form of continuously variable [wave form] physical quantities; e.g., pressure, resistance, rotation, temperature, voltage.

“analog device” means a device that operates with variables represented by continuously measured quantities such as pressures, resistances, rotations, temperatures, and voltages.

“analog-to-digital converter” means input related devices which translate an input device's [sensor] analog signals to the corresponding digital signals needed by the computer.

“analysis” means a course of reasoning showing that a certain result is a consequence of assumed premises.

“application software” means software designed to fill specific needs of a user.

“bar code” means a code representing characters by sets of parallel bars of varying thickness and separation that are read optically by transverse scanning.

“basic input/output system” means firmware that activates peripheral devices in a PC. Includes routines for the keyboard, screen, disk, parallel port and serial port, and for internal services such as time and date. It accepts requests from the device drivers in the operating system as well from application programs. It also contains autostart functions that test the system on startup and prepare the computer for operation. It loads the operating system and passes control to it.

“benchmark” means a standard against which measurements or comparisons can be made.

“block” means a string of records, words, or characters that for technical or logical purposes are treated as a unity.

“block check” means the part of the error control procedure that is used for determining that a block of data is structured according to given rules.

“bootstrap” means a short computer program that is permanently resident or easily loaded into a computer and whose execution brings a larger program, such an operating system or its loader, into memory.

“boundary value” means a data value that corresponds to a minimum or maximum input, internal, or output value specified for a system or component.

“boundary value analysis” means a selection technique in which test data are chosen to lie along “boundaries” of the input domain [or output range] classes, data structures, procedure parameters, etc.

“branch analysis” means a test case identification technique which produces enough test cases such that each decision has a true and a false outcome at least once.

“calibration” means ensuring continuous adequate performance of sensing, measurement, and actuating equipment with regard to specified accuracy and precision requirements.

“certification” means technical evaluation, made as part of and in support of the accreditation process that establishes the extent to which a particular computer system or network design and implementation meet a pre-specified set of requirements.

“computer system audit” means an examination of the procedures used in a computer system to evaluate their effectiveness and correctness and to recommend improvements.

“concept phase” means the initial phase of a software development project, in which user needs are described and evaluated through documentation.

“configurable, off-the-shelf software” means application software, sometimes general purpose, written for a variety of industries or users in a manner that permits users to modify the program to meet their individual needs.

“control flow analysis” means a software V&V task to ensure that the proposed control flow is free of problems, such as design or code elements that are unreachable or incorrect.

“controller” means hardware that controls peripheral devices such as a disk or display screen. It performs the physical data transfers between main memory and the peripheral device.

“conversational” means pertaining to a interactive system or mode of operation in which the interaction between the user and the system resembles a human dialog.

“coroutine” means a routine that begins execution at the point at which operation was last suspended, and that is not required to return control to the program or subprogram that called it.

“corrective maintenance” means maintenance performed to correct faults in hardware or software.

“critical control point” means a function or an area in a manufacturing process or procedure, the failure of which, or loss of control over, may have an adverse affect on the quality of the finished product and may result in an unacceptable health risk.

“data analysis” means evaluation of the description and intended use of each data item in the software design to ensure the structure and intended use will not result in a hazard. Data structures are assessed for data dependencies that circumvent isolation, partitioning, data aliasing, and fault containment issues affecting safety, and the control or mitigation of hazards.

“data integrity” means the degree to which a collection of data is complete, consistent, and accurate.

“data validation” means a process used to determine if data are inaccurate, incomplete, or unreasonable. The process may include format checks, completeness checks, check key tests, reasonableness checks and limit checks.

“design level” means the design decomposition of the software item; e.g., system, subsystem, program or module.

“design phase” means the period of time in the software life cycle during which the designs for architecture, software components, interfaces, and data are created, documented, and verified to satisfy requirements.

“diagnostic” means pertaining to the detection and isolation of faults or failures.

“different software system analysis” means Analysis of the allocation of software requirements to separate computer systems to reduce integration and interface errors related to safety. Performed when more than one software system is being integrated.

“dynamic analysis” means analysis that is performed by executing the program code.

“encapsulation” means a software development technique that consists of isolating a system function or a set of data and the operations on those data within a module and providing precise specifications for the module.

“end user” means a person, device, program, or computer system that uses an information system for the purpose of data processing in information exchange.

“error detection” means techniques used to identify errors in data transfers.

“error guessing” means the selection criterion is to pick values that seem likely to cause errors.

“error seeding” means the process of intentionally adding known faults to those already in a computer program for the purpose of monitoring the rate of detection and removal, and estimating the number of faults remaining in the program.

“failure analysis” means determining the exact nature and location of a program error in order to fix the error, to identify and fix other similar errors, and to initiate corrective action to prevent future occurrences of this type of error.

“Failure Modes and Effects Analysis” means a method of reliability analysis intended to identify failures, at the basic component level, which have significant consequences affecting the system performance in the application considered.

“FORTRAN” means an acronym for FORmula TRANslator, the first widely used high-level programming language. Intended primarily for use in solving technical problems in mathematics, engineering, and science.

“life cycle methodology” means the use of any one of several structured methods to plan, design, implement, test and operate a system from its conception to the termination of its use.

“logic analysis” means evaluates the safety-critical equations, algorithms, and control logic of the software design.

“low-level language” means the advantage of assembly language is that it provides bit-level control of the processor allowing tuning of the program for optimal speed and performance. For time critical operations, assembly language may be necessary in order to generate code which executes fast enough for the required operations.

“maintenance” means activities such as adjusting, cleaning, modifying, overhauling equipment to assure performance in accordance with requirements.

“modulate” means varying the characteristics of a wave in accordance with another wave or signal, usually to make user equipment signals compatible with communication facilities.

“Pascal” means a high-level programming language designed to encourage structured programming practices.

“path analysis” means analysis of a computer program to identify all possible paths through the program, to detect incomplete paths, or to discover portions of the program that are not on any path.

“quality assurance” means the planned systematic activities necessary to ensure that a component, module, or system conforms to established technical requirements.

“quality control” means the operational techniques and procedures used to achieve quality requirements.

“software engineering” means the application of a systematic, disciplined, quantifiable approach to the development, operation, and maintenance of software.

“software engineering environment” means the hardware, software, and firmware used to perform a software engineering effort.

“software hazard analysis” means the identification of safety-critical software, the classification and estimation of potential hazards, and identification of program path analysis to identify hazardous combinations of internal and environmental program conditions.

“software reliability” means the probability that software will not cause the failure of a system for a specified time under specified conditions.

“software review” means an evaluation of software elements to ascertain discrepancies from planned results and to recommend improvement.

“software safety change analysis” means analysis of the safety-critical design elements affected directly or indirectly by the change to show the change does not create a new hazard, does not impact on a previously resolved hazard, does not make a currently existing hazard more severe, and does not adversely affect any safety-critical software design element.

“software safety code analysis” means verification that the safety-critical portions of the design are correctly implemented in the code.

“software safety design analysis” means verification that the safety-critical portion of the software design correctly implements the safety-critical requirements and introduces no new hazards.

“software safety requirements analysis” means analysis evaluating software and interface requirements to identify errors and deficiencies that could contribute to a hazard.

“software safety test analysis” means analysis demonstrating that safety requirements have been correctly implemented and that the software functions safely within its specified environment.

“system administrator” means the person that is charged with the overall administration, and operation of a computer system. The System Administrator is normally an employee or a member of the establishment.

“system analysis” means a systematic investigation of a real or planned system to determine the functions of the system and how they relate to each other and to any other system.

“system design” means a process of defining the hardware and software architecture, components, modules, interfaces, and data for a system to satisfy specified requirements.

“top-down design” means pertaining to design methodology that starts with the highest level of abstraction and proceeds through progressively lower levels.

“traceability analysis” means the tracing of Software Requirements Specifications requirements to system requirements in concept documentation.

“validation” means establishing documented evidence which provides a high degree of assurance that a specific process will consistently produce a product meeting its predetermined specifications and quality attributes.

“validation, process” means establishing documented evidence which provides a high degree of assurance that a specific process will consistently produce a product meeting its predetermined specifications and quality characteristics.

“validation, prospective” means validation conducted prior to the distribution of either a new product, or product made under a revised manufacturing process, where the revisions may affect the product's characteristics.

“validation protocol” means a written plan stating how validation will be conducted, including test parameters, product characteristics, production equipment, and decision points on what constitutes acceptable test results.

“validation, retrospective” means validation of a process for a product already in distribution based upon accumulated production, testing and control data. Retrospective validation can also be useful to augment initial premarket prospective validation for new products or changed processes. Test data is useful only if the methods and results are adequately specific. Whenever test data are used to demonstrate conformance to specifications, it is important that the test methodology be qualified to assure that the test results are objective and accurate.

“validation, software” means. determination of the correctness of the final program or software produced from a development project with respect to the user needs and requirements. Validation is usually accomplished by verifying each stage of the software development life cycle.

“structured query language” means a language used to interrogate and process data in a relational database. Originally developed for IBM mainframes, there have been many implementations created for mini and micro computer database applications. SQL commands can be used to interactively work with a data base or can be embedded with a programming language to interface with a database.

“Batch” means a specific quantity of a drug or other material that is intended to have uniform character and quality, within specified limits, and is produced according to a single manufacturing order during the same cycle of manufacture.

“Component” means any ingredient intended for use in the manufacture of a drug product, including those that may not appear in such drug product.

“Drug product” means a finished dosage form, for example, tablet, capsule, solution, etc., that contains an active drug ingredient generally, but not necessarily, in association with inactive ingredients. The term also includes a finished dosage form that does not contain an active ingredient but is intended to be used as a placebo.

“Active ingredient” means any component that is intended to furnish pharmacological activity or other direct effect in the diagnosis, cure, mitigation, treatment, or prevention of disease, or to affect the structure or any function of the body of man or other animals. The term includes those components that may undergo chemical change in the manufacture of the vaccine and be present in the vaccine in a modified form intended to furnish the specified activity or effect.

“Inactive ingredient” (a.k.a. excipient) means a substance used as a carrier for the active ingredients of a vaccine. In addition, excipients can be used to aid the process by which a vaccine is manufactured. The active substance is then dissolved or mixed with an excipient. Excipients are also sometimes used to bulk up formulations with very potent active ingredients, to allow for convenient and accurate dosage. Once the active ingredient has been purified, it cannot stay in purified form for very long. In many cases it will denature, fall out of solution, or stick to the sides of the container. To stabilize the active ingredient, excipients are added to ensure that the active ingredient stays active, and is stable for a long enough period of time that the shelf-life of the product makes it competitive with other products. Examples of excipients, include but are not limited to, antiadherents, binders, coatings, disintegrants, fillers, dilutents, flavors, colors, lubricants, and preservatives.

“In-process material” means any material fabricated, compounded, blended, or derived by chemical reaction that is produced for, and used in, the preparation of the drug product.

“Lot number, control number, or batch number” means any distinctive combination of letters, numbers, or symbols, or any combination thereof, from which the complete history of the manufacture, processing, packing, holding, and distribution of a batch or lot of drug product or other material can be determined.

“Quality control unit” means any person or organizational element designated by the firm to be responsible for the duties relating to quality control.

“Acceptance criteria” means the product specifications and acceptance/rejection criteria, such as acceptable quality level and unacceptable quality level, with an associated sampling plan, that are necessary for making a decision to accept or reject a lot or batch.

“Intelligent execution system” (“IES”) means an integrated hardware and software solution designed to measure and control activities in the production areas of vaccine manufacturing to increase productivity and improve quality. Also referred to as Manufacturing Execution System. For the purposes of this definition an IES relates only to vaccine manufacturing processes and systems. The use of an IES of the present invention not relating to the manufacturing, storing, or production of vaccines is specifically excluded from the definition of an IES.

“Process analytical technology” (a.k.a. PAT) means a mechanism to design, analyze, and control pharmaceutical manufacturing processes through the measurement of critical process parameters and quality attributes.

“New molecular entity” (a.k.a. NME or New Chemical Entity (“CNE”)) means a drug that contains no active moiety that has been approved by FDA. An active moiety means the molecule or ion, excluding those appended portions of the molecule that cause the drug to be an ester, salt (including a salt with hydrogen or coordination bonds), or other noncovalent derivative (such as a complex, chelate, or clathrate) of the molecule, responsible for the physiological or pharmacological action of the drug substance.

“Chromatography” means collectively a family of laboratory techniques for the separation of mixtures. It involves passing a mixture which contains the analyte through a stationary phase, which separates it from other molecules in the mixture and allows it to be isolated.

“Innoculation” means the process of artificial induction of immunity against various infectious diseases. The microorganism used in an inoculation is called the inoculant or inoculum.

“Fermentation” means the process of energy production in a cell in an anaerobic environment (with no oxygen present).

“Formulation” means the process in which different chemical substances are combined to a pure drug substance (i.e. vaccine) to produce a final medicinal product (i.e. vaccine in product form)

“Filling” means the process of placing the formulation of a final medicinal product into a dosage form.

“Dosage form” means the physical form of a dose of medication. Examples of dosalge forms, include but are not limited to, Tablets, Capsules (hard, soft, etc.), Suppositories, Injections, Creams, Ointments, Eye drops, Ear drops, Inhalations, Nasal sprays, Transdermal patches, Emulsions, Suspensions, Dispersions, Solutions, Implants, Lotions, Inserts, Powders, Gels, Pastes. The route of administration is dependent on the dosage form of a given drug.

### II.) Software Program

The invention provides for a software program that is programmed in a high-level or low-level programming language, preferably a relational language such as structured query language which allows the program to interface with an already existing program or a database. Other programming languages include but are not limited to C, C++, FORTRAN, Java, Perl, Python, Smalltalk and MS visual basic. Preferably, however, the program will be initiated in parallel with the vaccine manufacturing process or quality assurance (“QA”) protocol. This will allow the ability to monitor the vaccine manufacturing and QA process from its inception. However, in some instances the program can be bootstrapped into an already existing program that will allow monitoring from the time of execution (i.e. bootstrapped to configurable off-the-shelf software).

It will be readily apparent to one of skill in the art that the preferred embodiment will be a software program that can be easily modified to conform to numerous software-engineering environments. One of ordinary skill in the art will understand and will be enabled to utilize the advantages of the invention by designing the system with top-down design. The level of abstraction necessary to achieve the desired result will be a direct function of the level of complexity of the process that is being monitored. For example, the critical control point for monitoring an active ingredient versus an inactive ingredient may not be equivalent. Similarly, the critical control point for monitoring an in-process material may vary from component to component and often from batch to batch.

One of ordinary skill will appreciate that to maximize results the ability to amend the algorithm needed to conform to the validation and QA standards set forth by the quality control unit on each step during vaccine manufacture will be preferred. This differential approach to programming will provide the greatest level of data analysis leading to the highest standard of data integrity.

The preferred embodiments may be implemented as a method, system, or program using standard software programming and/or engineering techniques to produce software, firmware, hardware, or any combination thereof. The term “computer product” as used herein is intended to encompass one or more computer programs and data files accessible from one or more computer-readable devices, firmware, programmable logic, memory devices (e.g. EEPROM's, ROM's, PROM's, RAM's, SRAM's, etc.) hardware, electronic devices, a readable storage diskette, CD-ROM, a file server providing access to programs via a network transmission line, wireless transmission media, signals propagating through space, radio waves, infrared signals, etc.

The invention further provides articles (e.g., computer products) comprising a machine-readable medium including machine-executable instructions, computer systems and computer implemented methods to practice the methods of the invention. Accordingly, the invention provides computers, computer systems, computer readable mediums, computer programs products and the like having recorded or stored thereon machine-executable instructions to practice the methods of the invention. As used herein, the words “recorded” and “stored” refer to a process for storing information on a computer medium. A skilled artisan can readily adopt any known methods for recording information on a computer to practice the methods of the invention.

The computer processor used to practice the methods of the invention can be a conventional general-purpose digital computer, e.g., a personal workstation computer, including conventional elements such as microprocessor and data transfer bus.

In one embodiment, the invention provides for methods of interfacing a software program with a vaccine manufacturing system whereby the software program is integrated into the vaccine manufacturing process and control of the vaccien manufacturing process is attained. The integration can be used for routine monitoring, quality control, maintenance, hazard mitigation, validation, etc.

The invention further comprises implementing the software program to multiple devices used in vaccine manufacture to create an IES used to monitor and control the entire vaccine manufacturing process.

The invention further comprises implementing the IES into multiple vaccine product lines whereby simultaneous vaccine production lines are monitored using the same system.

The invention further comprises implementation of the IES and software program described herein into the media filtration processes, the aeration processes, the inoculation processes, the fermentation processes, the exhaust processes, the depth filtration processes, the tangential flow filtration, the buffer filtration processes, the capture chromotagraphy processes, the liquid filtration, the concentration diafiltration processes, the purification chromatography processes, the air filtration processes, the storage processes, the polishing chromatography processes, the virus removal filtration, the formulation processes, and the filling processes subset of the vaccine manufacturing process whereby the data compiled by the subset processes is tracked continuously overtime and said data is used to analyze the subset processes and whereby said data is integrated and used to analyze the quality control process of the vaccine manufacturing process at-large.

It will also be appreciated by those skilled in the art that the various steps herein for virus/vaccine production are not required to be all performed or exist in the same production series. Thus, while in some embodiments, all steps and/or software programs or and IES described or mentioned herein are performed or exist, in other embodiments, one or more steps are optionally, e.g., omitted, changed (in scope, order, placement, etc.) or the like. Accordingly, those of skill in the art will recognize that many modifications may be made without departing from the scope of the present invention.

### III.) Analysis

The invention provides for a method of analyzing data that is compiled as a result of the manufacturing of vaccines. Further the invention provides for the analysis of data that is compiled as a result of a QA program used to monitor the manufacture of vaccines in order to maintain the highest level of data integrity. In one embodiment, the parameters of the data will be defined by the quality control unit. Generally, the quality control unit will provide endpoints that need to be achieved to conform to cGMP regulations or in some instances an internal endpoint that is more restrictive to the minimum levels that need to be achieved.

In a preferred embodiment, the invention provides for data analysis using boundary value analysis. The boundary value will be set forth by the quality control unit. Using the boundary values set forth for a particular phase of manufacture the algorithm is defined. Once the algorithm is defined, an algorithm analysis (i.e. logic analysis) takes place. One of skill in the art will appreciate that a wide variety of tools are used to confirm algorithm analysis such as an accuracy study processor.

One of ordinary skill will appreciate that different types of data will require different types of analysis. In a further embodiment, the program provides a method of analyzing block data via a block check. If the block check renders an affirmative analysis, the benchmark has been met and the analysis continues to the next component. If the block check renders a negative the data is flagged via standard recognition files known in the art and a hazard analysis and hazard mitigation occurs.

In a further embodiment, the invention provides for data analysis using branch analysis. The test cases will be set forth by the quality control unit.

In a further embodiment, the invention provides for data analysis using control flow analysis. The control flow analysis will calibrate the design level set forth by the quality control unit which is generated in the design phase.

In a further embodiment, the invention provides for data analysis using failure analysis. The failure analysis is initiated using the failure benchmark set forth by the quality control unit and then using standard techniques to come to error detection. The preferred technique will be top-down. For example, error guessing based on quality control group parameters which are confirmed by error seeding.

In a further embodiment, the invention provides for data analysis using path analysis. The path analysis will be initiated after the design phase and will be used to confirm the design level. On of ordinary skill in the art will appreciate that the path analysis will be a dynamic analysis depending on the complexity of the program modification. For example, the path analysis on the output of an end product will be inherently more complex that the path analysis for the validation of an in-process material. However, one of ordinary skill will understand that the analysis is the same, but the parameters set forth by the quality control unit will differ.

The invention provides for a top-down design to software analysis. This preferred embodiment is advantageous because the parameters of analysis will be fixed for any given process and will be set forth by the quality control unit. Thus, performing software safety code analysis then software safety design analysis, then software safety requirements analysis, and then software safety test analysis will be preferred.

The aforementioned analysis methods are used for several non-limiting embodiments, including but not limited to, validating QA software, validating vaccine manufacturing processes and systems, and validating process designs wherein the integration of the system design will allow for more efficient determination of acceptance criteria in a batch, in-process material, batch number, control number, and lot number and allow for increased access time thus achieving a more efficient cost-saving vaccine manufacturing process.

### IV. Intelligent Execution Systems (IES)

In one embodiment, the software program or computer product, as the case may be, is integrated into an intelligent execution system that controls the vaccine manufacturing process. It will be understood by one of skill in the art that the software programs or computer products integrates the hardware via generally understood devices in the art (i.e. attached to the analog device via an analog to digital converter).

The software program or computer product is integrated into the intelligent execution system on a device-by-device basis. As previously set forth, the acceptance criteria of all devices used in vaccine manufacture for the purposes of the intelligent execution system are determined by the quality control unit. The analysis of the vaccine manufacturing occurs using any of the methods disclosed herein. (See, section III entitled “Analysis”). The program monitors and processes the data and stores the data using standard methods. The data is provided to an end user or a plurality of end users for assessing the quality of data generated by the device or devices. Furthermore, the data is stored for comparative analysis to previous batches to provide a risk-based assessment in case of failure. Using the historical analysis will provide a more streamlined vaccine manufacturing process and will monitor to ensure that product quality is maximized. Utilizing the historical record will provide vaccine manufacturers an “intelligent” perspective to manufacturing. Over time, the intelligent execution system will teach itself and modify the vaccine manufacturing process in a way to obviate previous failures while at the same time continuously monitoring for new or potential failures. In addition, the invention comprises monitoring the data from initial process, monitoring the data at the end process, and monitoring the data from a routine maintenance schedule to ensure the system maintain data integrity and validation standards predetermined by the quality control unit.

### V.) Kits/Articles of Manufacture

For use in basic input/output systems, hardware calibrations, software calibrations, computer systems audits, computer system security certification, data validation, different software system analysis, quality control, and the manufacturing of vaccine products described herein, kits are within the scope of the invention. Such kits can comprise a carrier, package, or container that is compartmentalized to receive one or more containers such as boxes, shrink wrap, and the like, each of the container(s) comprising one of the separate elements to be used in the method, along with a program or insert comprising instructions for use, such as a use described herein.

The kit of the invention will typically comprise the container described above and one or more other containers associated therewith that comprise materials desirable from a commercial and user standpoint, programs listing contents and/or instructions for use, and package inserts with instructions for use.

A program can be present on or with the container. Directions and or other information can also be included on an insert(s) or program(s) which is included with or on the kit. The program can be on or associated with the container.

The terms “kit” and “article of manufacture” can be used as synonyms.

The article of manufacture typically comprises at least one container and at least one program. The containers can be formed from a variety of materials such as glass, metal or plastic.

### EXAMPLES

Various aspects of the invention are further described and illustrated by way of the several examples that follow, none of which is intended to limit the scope of the invention.

### Example 1

### Utilizing the IES to Monitor the Upstream Processing System for Vaccine Manufacture

The upstream part of vaccine manufacture refers to the first step in which biomolecules are grown, usually by bacterial or mammalian cell lines in bioreactors. When they reach the desired density (for batch and fed batch cultures) they are transported the cell harvest and product separation systems. Generally speaking and for purposes of this example, fermentation is a process of energy production in a cell in an anaerobic environment (with no oxygen present). In common usage fermentation is a type of anaerobic respiration. When a particular organism is introduced into a selected growth medium, the medium is inoculated with the particular organism. Growth of the inoculum does not occur immediately, but takes a little while. This is the period of adaptation, called the lag phase. Following the lag phase, the rate of growth of the organism steadily increases, for a certain period, this period is the log or exponential phase. After a certain time of exponential phase, the rate of growth slows down, due to the continuously falling concentrations of nutrients and/or a continuously increasing (accumulating) concentrations of toxic substances. This phase, where the increase of the rate of growth is checked, is the deceleration phase. After the deceleration phase, growth ceases and the culture enters a stationary phase or a steady state. The biomass remains constant, except when certain accumulated chemicals in the culture lyse the cells (chemolysis). Unless other micro-organisms contaminate the culture, the chemical constitution remains unchanged. Mutation of the organism in the culture can also be a source of contamination, called internal contamination.

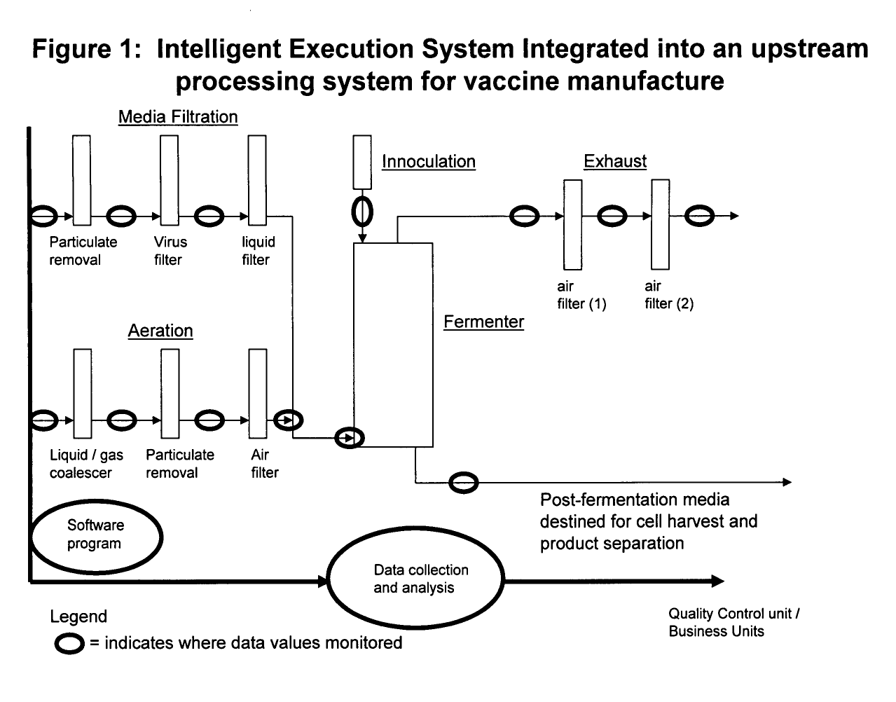

Prior to fermentation, raw media processes through a media filtration system. The raw material is ran through a particulate removal phase, a virus filter phase, and a liquid filter phase (See, FIG. 1). The media is filtered and purified to the proper parameters and is sent to the fermentor.

Additionally, any microbe requires oxygen, carbon, and water (among other things) for growth. Accordingly, and concurrently with the media filtration processes an aeration process is ran through a liquid/gas coalescer phase, a particulate removal phase, and an air filter phase (FIG. 1). The aeration process is completed and the product is sent to the fermentor. Concurrently, the inoculate is sent to the fermentor for inoculation (FIG. 1).

Fermentation occurs until the vaccine product has entered a steady state. At steady state, impurities in the air are filtered and disposed of via air filters in an exhaust system (FIG. 1).

In one embodiment, the IES is integrated into the upstream processing system used in vaccine manufacture. It will be understood by one of skill in the art that the IES integrates the hardware via generally understood devices in the art (i.e. attached to the analog device via an analog to digital converter). The IES is integrated into the upstream processing system on a device-by-device basis. As previously set forth, the acceptance criteria of all devices used in the vaccine manufacture for the purposes of the upstream process are determined by the quality control unit. The analysis of the software and hardware occurs using any of the methods disclosed herein. The IES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined upstream process and will monitor to ensure that the upstream processing system data is integrated into cell harvest and product separation processes.

In addition, the invention comprises monitoring the data from initial process, monitoring the data at the end process, and monitoring the data from a routine maintenance schedule to ensure the system maintain data integrity and validation standard predetermined by the quality control unit. (See, FIG. 1).

In one embodiment, the monitoring and analysis of the upstream processing systems achieves a step of integration into an intelligent execution system whereby manufacturing productivity and product quality are increased. Costs are streamlined over time.

### Example 2

### Utilizing the IES to Monitor the Cell Harvest and Product Separation System for Vaccine Manufacture

Cell harvesting and separation refers to purification for the sole purpose of measuring a component or components of a vaccine, and may deal with sample sizes as small as a single cell. Once the cell culture has entered a steady state (See, Example 1 entitled “Utilizing the IES to monitor the upstream processing system for vaccine manufacture”) the cell cultures are harvested and separated using methods known in the art. In maintaining the cell cultures, Cells are grown and maintained at an appropriate temperature and gas mixture (typically between, 25-45° C. (preferrably, 37° C.) and 2-8 CO₂ (preferrably, 5 CO₂) in a cell incubator. Culture conditions vary widely for each cell type, and variation of conditions for a particular cell type can result in different phenotypes being expressed. Aside from temperature and gas mixture, the most commonly varied factor in culture systems is the growth medium (this is especially true in vaccine manufacture). Recipes for growth media can vary in pH, glucose concentration, growth factors, and the presence of other nutrient components. As cells generally continue to divide in culture, they generally grow to fill the available area or volume. This can generate several issues, (i) nutrient depletion in the growth media, (ii) accumulation of apoptotic/necrotic (dead) cells, (iii) Cell-to-cell contact can stimulate cell cycle arrest, causing cells to stop dividing known as contact inhibition, or (iv) Cell-to-cell contact can stimulate promiscuous and unwanted cellular differentiation. These issues can be dealt with using tissue culture methods that rely on sterile technique. These methods aim to avoid contamination with bacteria or yeast that will compete with mammalian cells for nutrients and/or cause cell infection and cell death. In order to remedy these problems, cell culture manipulations are common. Amongst the common manipulations carried out on culture cells are media changes, passaging cells, and transfecting cells. The purpose of media changes is to replenish nutrients and avoid the build up of potentially harmful metabolic byproducts and dead cells. In the case of suspension cultures, cells can be separated from the media by methods known in the art and resuspended in fresh media. In the case of adherent cultures, the media can be removed directly by methods commonly known in the art and replaced. To measure the specific component or components of a vaccine, a cell culture assay is commonly used to assess the cytotoxicity of a material. This refers to the in vitro assessment of material to determine whether or not it releases toxic chemicals in sufficient quantities to kill cells either directly or indirectly through the inhibition of cell metabolic pathways. Three common methods are known in the art. A Direct contact method, an Agar diffusion method, and an elution method. Each method has its own advantages and disadvantages, and some are more suitable for certain applications than others. For example, the direct contact method offers conditions which are most similar to the physiological environment but the cells are susceptible to trauma if the material moves. The agar diffusion method is good for materials with high densities and offers an even concentration gradient for potential toxicants, but there is a serious risk of the cells going into thermal shock when they are overlaid with agar. The elution method is best for applications, which might require extra incubation time, but additional time and steps are required for preparing such a test.

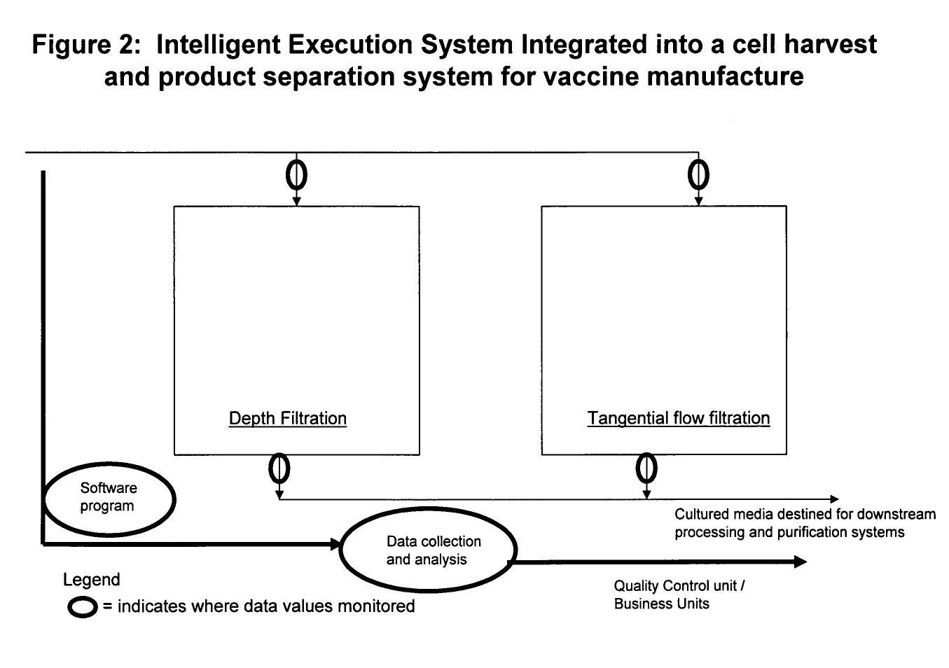

Prior to downstream processing, steady state culture is harvested and separated for testing. Accordingly, culture is purified in a depth filtration process and a tangential flow filtration system (See, FIG. 2). The culture is filtered, purified, and tested. If the quality tests are negative, a cell culture manipulation occurs. If the quality tests are positive the culture proceeds to downstream processing.

In one embodiment, the IES is integrated into the cell harvesting and separation system used in vaccine manufacture. It will be understood by one of skill in the art that the IES integrates the hardware via generally understood devices in the art (i.e. attached to the analog device via an analog to digital converter). The IES is integrated into the cell harvesting and separation system on a device-by-device basis. As previously, set forth, the acceptance criteria of all devices used in the vaccine manufacture for the purposes of the cell harvesting and separation are determined by the quality control unit. The analysis of the software and hardware occurs using any of the methods disclosed herein. The IES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined upstream process and will monitor to ensure that the cell harvesting and separation system data is integrated into downstream processing systems.

In addition, the invention comprises monitoring the data from initial process, monitoring the data at the end process, and monitoring the data from a routine maintenance schedule to ensure the system maintain data integrity and validation standard predetermined by the quality control unit. (See, FIG. 2).

In one embodiment, the monitoring and analysis of the cell harvesting and separation systems achieves a step of integration into an intelligent execution system whereby manufacturing productivity and product quality are increased. Costs are streamlined over time.

### Example 3

### Utilizing the IES to Monitor the Downstream Processing and Purification System for Vaccine Manufacture

The downstream processing part of vaccine manufacture refers to the part where the cell mass from the upstream and cell harvest and separation systems are processed to meet purity and quality requirements. Downstream processing implies manufacture of a purified product fit for a specific use, generally in marketable quantities. Downstream processing is usually divided into three main sections, a capture section, a purification section and a polishing section. It is an essential step in the manufacture of vaccines. It is understood in the art that downstream processing operations are divided into four groups, which are applied in order to bring a product from its natural state as a cell or fermentation broth through progressive improvements in purity and concentration.

The first step involves the capture of the product as a solute in a particulate-free liquid, for example the separation of cells, cell debris, or other particulate matter from fermentation broth containing an antibiotic. Typical operations to achieve this are filtration, centrifugation, sedimentation, flocculation, electro-precipitation, and gravity settling. Additional operations such as grinding, homogenization, or leaching, required to recover products from solid sources such as plant and animal tissues are usually included in this group.

The second step is removal of those components whose properties vary substantially from that of the desired product. Generally, water is the chief impurity and isolation steps are designed to remove most of it, reducing the volume of material to be handled and concentrating the product. Solvent extraction, adsorption, ultrafiltration, and precipitation are some of the operations involved.

The third step is done to separate those contaminants that resemble the product very closely in physical and chemical properties. This stage contributes a significant fraction of the entire downstream processing expenditure in terms of cost. Examples of operations include affinity, size exclusion and reversed phase chromatography, crystallization, and fractional precipitation.

The final processing step which ends with packaging of the product in a form that is stable, easily transportable and convenient. Crystallization, desiccation, lyophilization and spray drying are typical operations. Depending on the product and its intended use, polishing may also include operations to sterilize the product and remove or deactivate trace contaminants that might compromise product safety. Such operations might include the removal of viruses or depyrogenation.

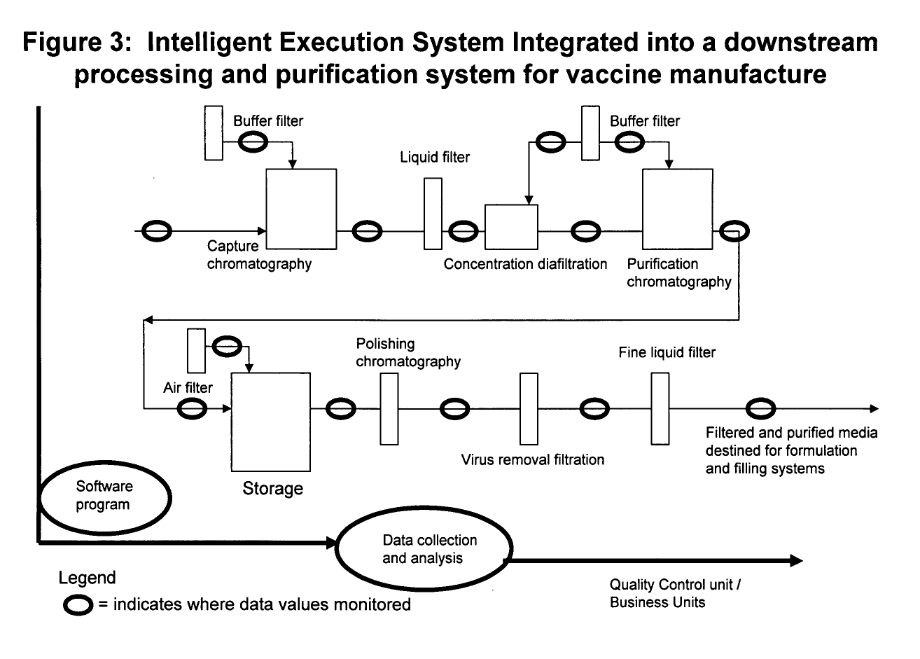

In one embodiment, the harvested cell culture (See, Example 2 entitled “Utilizing the IES to monitor the cell harvest and product separation system for vaccine manufacture) is ran through a capture chromatography phase (See, FIG. 3). The culture is filtered and purified to the proper parameters and is sent to the purification chromatography phase.

Once the product is purified, it is stored using standard methods in a storage tank (FIG. 3). The product is transferred to a polishing chromatography phase where it is filtered, purified, and forwarded to formulation and filling (FIG. 3).

In one embodiment, the IES is integrated into the downstream processing system used in vaccine manufacture. It will be understood by one of skill in the art that the IES integrates the hardware via generally understood devices in the art (i.e. attached to the analog device via an analog to digital converter). The IES is integrated into the downstream processing system on a device-by-device basis. As previously, set forth, the acceptance criteria of all devices used in the vaccine manufacture for the purposes of the downstream process are determined by the quality control unit. The analysis of the software and hardware occurs using any of the methods disclosed herein. The IES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined upstream process and will monitor to ensure that the upstream processing system data is integrated into cell harvest and product separation processes. In addition, the invention comprises monitoring the data from initial process, monitoring the data at the end process, and monitoring the data from a routine maintenance schedule to ensure the system maintain data integrity and validation standard predetermined by the quality control unit. (See, FIG. 3).

In one embodiment, the monitoring and analysis of the downstream processing systems achieves a step of integration into an intelligent execution system whereby manufacturing productivity and product quality are increased. Costs are streamlined over time.

### Example 4

### Utilizing the IES to Monitor a Plasmid (DNA) Vaccine System

In recent years a new type of vaccine, created from an infectious agent's DNA called DNA vaccination has been developed. It works by insertion (and expression, triggering immune system recognition) into human or animal cells, of viral or bacterial DNA. Some cells of the immune system that recognize the proteins expressed will mount an attack against these proteins and cells expressing them. Because these cells live for a very long time, if the pathogen that normally expresses these proteins is encountered at a later time, they will be attacked instantly by the immune system. One advantage of DNA vaccines is that they are very easy to produce and store. Note that while most vaccines are created using inactivated or attenuated compounds from micro-organisms, synthetic vaccines are composed mainly or wholly of synthetic peptides, carbohydrates or antigens. Instead of taking a damaged pathogen, a single gene from that pathogen is artificially copied and multiplied. That gene is then injected into a muscle. Muscle cells tend to take up this gene and use it as one of their own genes, making the product the gene describes. The immune system will recognize that product as foreign, and remember it, just like it does in the “classic” vaccination. This provides several advantages; first, the gene is made artificially, and can therefore be much more pure than any vaccine made directly from pathogens. Second, it is only one of the many genes necessary for the pathogen to reproduce. Accordingly, that small part is enough for the immune system to recognize its enemy, but not enough to become a danger to the body. Third, several different genes can be mixed and injected simultaneously, making it possible to vaccinate against many variants of a pathogen, or against several different pathogens, at the same time. Finally, the genes are cheap to produce, do not require cooling, and can be stored for years.

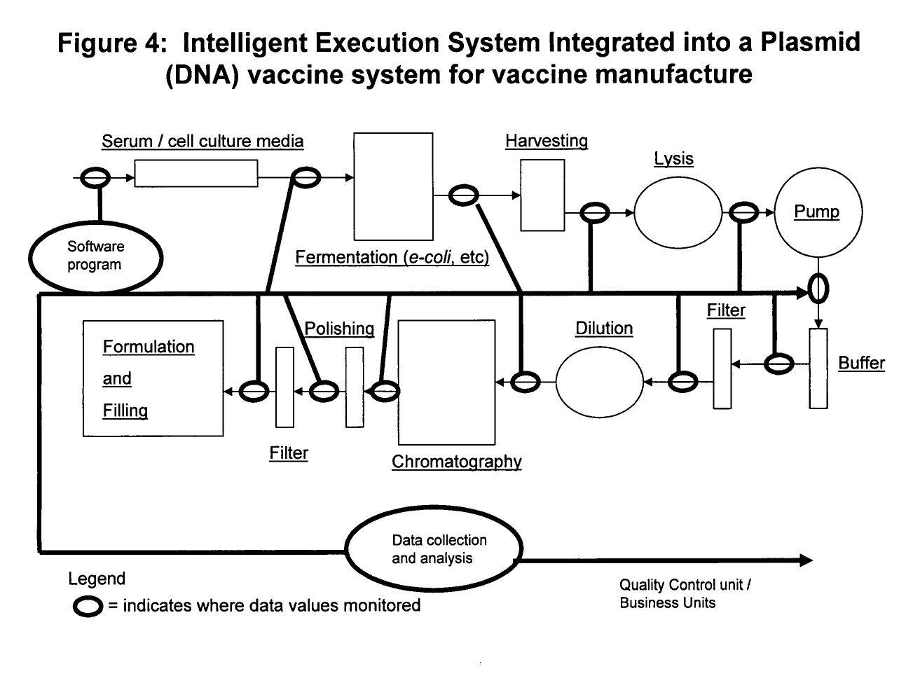

In one embodiment, the cell culture media is ran through fermentation phase and is harvested and sent to a lysis phase. The culture continues though the system. A pump sends the culture though a buffer phase, which is then filtered, then diluted and then sent to a chromatography phase. The culture is polished, filtered and then sent to formulation and filling. a capture chromatography phase (See, FIG. 4).

In one embodiment, the IES is integrated into the DNA vaccine system used in vaccine manufacture. It will be understood by one of skill in the art that the IES integrates the hardware via generally understood devices in the art (i.e. attached to the analog device via an analog to digital converter). The IES is integrated into the DNA vaccine system on a device-by-device basis. As previously, set forth, the acceptance criteria of all devices used in the DNA vaccine manufacture are determined by the quality control unit. The analysis of the software and hardware occurs using any of the methods disclosed herein. The IES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined DNA vaccine manufacturing process and will monitor to ensure that the DNA vaccine system data is integrated at-large.

In addition, the invention comprises monitoring the data from initial process, monitoring the data at the end process, and monitoring the data from a routine maintenance schedule to ensure the DNA vaccine system maintain data integrity and validation standards predetermined by the quality control unit. (See, FIG. 4).

In one embodiment, the monitoring and analysis of the DNA vaccine systems achieves a step of integration into an intelligent execution system whereby manufacturing productivity and product quality are increased. Costs are streamlined over time.

### Example 5

### Utilizing the IES to Monitor a Formulation and Fill System for Vaccine Manufacture

Vaccine formulation is the process in which different chemical substances are combined to a pure vaccine substance to produce a final vaccine product. Formulation studies involve developing a preparation of the vaccine, which is both stable and acceptable to the patient. Formulation studies consider such factors as particle size, polymorphism, pH, and solubility, as all of these can influence bioavailability and hence the immunogenicity of a vaccine. Generally, the vaccine must be combined with inactive additives by a method, which ensures that the quantity of vaccine present is consistent in each dosage unit. The dosage should have a uniform appearance as well as other uniform properties.

Generally, it is unlikely that a final formulation will be complete by the time clinical trials commence. This means that simple preparations are developed initially for use in phase I clinical trials. Proof the long-term stability of these formulations is not required, as they will be used (tested) in a matter of days. Consideration has to be given to what is called the drug load—the ratio of the active drug to the total contents of the dose. By the time phase III clinical trials are reached, the formulation of the vaccine should have been developed to be close to the preparation that will ultimately be used in the market. Knowledge of stability is essential by this stage, and conditions must have been developed to ensure that the vaccine is stable in the preparation. If the vaccine proves unstable, it will invalidate the results from clinical trials since it would be impossible to know what the administered dose actually was. Stability studies are carried out to test whether temperature, humidity, oxidation, or photolysis (ultraviolet light or visible light) have any effect, and the preparation is analyzed to see if any degradation products have been formed.

It is also important to check whether there are any unwanted interactions between the preparation and the container. If a plastic container is used, tests are carried out to see whether any of the ingredients become adsorbed on to the plastic, and whether any plasticizers, lubricants, pigments, or stabilizers leach out of the plastic into the preparation. Even the adhesives for the container label need to be tested, to ensure they do not leach through the plastic container into the preparation.

Once the final sterility tests, etc. have been run and the data analyzed using the methods described herein, a lot release is initiated. The lot release of the vaccine must be controlled and only released for its intended use if it meets prospectively defined quality control criteria (specifications). Lots should be controlled at the levels of in-process tests, bulk(s), and final container. Final containers must be controlled for identity, purity, potency, sterility (parenteral products) or bioburden (non-parenterals), and the general safety test.

In one embodiment, the IES is integrated into the formulation and filling system used in vaccine manufacture. It will be understood by one of skill in the art that the IES integrates the hardware via generally understood devices in the art (i.e. attached to the analog device via an analog to digital converter). The IES is integrated into the formulation and filling system on a device-by-device basis. As previously, set forth, the acceptance criteria of all devices used in the vaccine manufacture for the purposes of formulation and filling are determined by the quality control unit. The analysis of the software and hardware occurs using any of the methods disclosed herein. The IES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined formulation and filling process and will monitor to ensure that the formulation and filling system data is integrated into the final vaccine product.

In addition, the invention comprises monitoring the data from initial process, monitoring the data at the end process, and monitoring the data from a routine maintenance schedule to ensure the system maintain data integrity and validation standard predetermined by the quality control unit.

In one embodiment, the monitoring and analysis of the formulation and filling systems achieves a step of integration into an intelligent execution system whereby manufacturing productivity and product quality are increased. Costs are streamlined over time.

### Example 6

### Integration of IES and Methods into a Comprehensive Cost-Saving System

The invention comprises an IES and method integrated into a comprehensive cost-saving vaccine manufacturing system. A user, preferably a system administrator, logs onto the system via secure means (i.e. password or other security measures known in the art) and inputs the boundary values for a particular component of the vaccine manufacturing process. The input is at the initial stage, the end product state, or any predetermined interval in between that has been established for routine maintenance by the quality control unit. The data is generated using any one of the various analysis methods described herein (as previously stated the type of analysis used is functional to the device or protocol being monitored or evaluated). Subsequent to the data analysis, any modifications or corrective action to the vaccine manufacturing process is implemented. The data is then stored by standard methods known in the art. Scheduled analysis of the stored data is maintained to provide a preventative maintenance of the vaccine manufacturing process. Over time, costs are reduced due to the tracking of data and analysis of troubled areas and frequency of hazards that occur on any given device in the vaccine manufacturing process. The system is implemented on every device which plays a role in vaccine manufacturing. The data compiled from every device is analyzed using the methods described herein.

The present invention is not to be limited in scope by the embodiments disclosed herein, which are intended as single illustrations of individual aspects of the invention, and any that are functionally equivalent are within the scope of the invention. Various modifications to the models, methods, and life cycle methodology of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

1) An “intelligent execution system” (“IES”) by a process comprising,
a) contacting a plurality of devices used in vaccine manufacture with a computer memory having computer executable instructions;
b) monitoring data generated by said devices during vaccine manufacture;
c) maintaining the data to provide a historic record;
d) analyzing said data to make a quality assessment of said vaccine manufacture.

2) The IES of claim 1, wherein said device is a cell harvest system.

3) The IES of claim 1, wherein said device is a purification system.

4) The IES of claim 1, wherein said device is a bioreactor.

5) The IES of claim 1, wherein said device is a filtration system.

6) The IES of claim 1, wherein said data relates to an acceptance criteria of an active ingredient used to manufacture vaccines.

7) The IES of claim 1, wherein said data relates to an acceptance criteria of an in-process material used to manufacture vaccines.

8) The IES of claim 1, wherein said data relates to an acceptance criteria of an inactive ingredient used to manufacture vaccines.

9) The IES of claim 1, wherein said quality assessment further comprises modifying said vaccine manufacture.

10) The IES of claim 1, wherein the monitoring is continuous.

11) A kit comprising the IES of claim 1.

12) A method of monitoring a vaccine manufacturing process said method comprising,
a) deriving an algorithm implemented in computer-readable instructions that performs data analysis on a vaccine manufacturing process;
b) integrating said algorithm into a vaccine manufacturing process whereby actual monitoring of the vaccine manufacturing is attained.

13) The method of claim 12 further comprising maintaining a historical record of the data analysis.

14) The method of claim 12, wherein the vaccine manufacturing process is a plasmid (DNA) based process.

15) The method of claim 12, wherein the monitoring is part of routine maintenance.

16) A method of monitoring quality control of a vaccine manufacturing process said method comprising,
a) contacting a computer memory having computer executable instructions to a critical control point of a vaccine manufacturing process;
b) monitoring data generated by said critical control point during vaccine manufacture;
c) analyzing said data in a continuous manner during vaccine manufacture to ensure purity and consistency of an ingredient used in vaccine manufacture.

17) The method of claim 16, wherein the ingredient is an inactive ingredient.

18) The method of claim 16, wherein the vaccine manufacturing process is a plasmid (DNA) vaccine process using at least a chromatography system.

19) The method of claim 16, wherein the vaccine manufacturing process further comprises a downstream processing system.
